(19) United States
(12) Patent Application Publication
(10) Pub. No.: US 2003/0152052 A1
(43) Pub. Date: Aug. 14, 2003

(54) Data transmission apparatus

(76) Inventors: Sami Kekki, Helsinki (FI); Fabio Longoni, Malaga (ES); Roland Wolker, Espoo (FI)

Correspondence Address: Docket Clerk, PO Box 802432, Dallas, TX, 75380, US

(21) Appl. No.: 10/149,798

(22) PCT Filed: Dec. 18, 2000
(86) PCT No.: PCT/IB00/02023

(30) Foreign Application Priority Data
Dec. 16, 1999 (GB) 9929794.7

(51) Int. Cl. H04B 7/216

(52) U.S. Cl. 370/335; 370/342

(57) ABSTRACT

Data transmission apparatus for transmitting the data of a data frame as a plurality of packets, comprising: segmentation apparatus capable of identifying delay-critical data within the data frame, and forming a plurality of packets comprising data of the data frame, wherein the identified data is formed in to one or more packets capable of being decoded independently of the other packets; and a transmitter for transmitting the packets.

The present invention relates to apparatus for the transmission of data of a data frame as a plurality of packets, and in particular to the identification of delay-critical data and Transmission of packets containing such data.

In networks such as mobile telecommunications networks, data signals can be transmitted between components of the network in the form of data frames. It is common for these signals to carry delay-critical data such as signal quality information or timing information. Such data is termed “delay-critical” because it is generally not possible for the receiving equipment to fully deal with the data frame until it has received this data. For example, if delay-critical information is signal-to-interference information being transmitted within voice traffic from a mobile phone to a base station within a mobile telecommunications network, the base station will not be able to respond with the correct power change instruction to deal with the quality of signal being received from the phone, until it has received this data. Any delays incurred whilst waiting for this data might lead to a drop in standard of service for the user.

Since a number of data signals and therefore a number of data frames carrying data from different data signals are being transmitted between network components, it is usual for data frames containing data from different data signals to be transmitted interspersed with one another. Furthermore, if data frames are too large to be transmitted as a whole, they are often segmented into a number of data packets, often resulting in data packets forming part of different data frames being transmitted interspersed with one another. The order of Transmission of such packets can be determined using various methods depending on the network, but any such method is likely to result in a certain degree of delay before an entire data frame of any given data signal is received by the receiving component

When the receiving component has received an entire data frame, it can proceed to decode it. This involves reassembling the data packets so that delay-critical data is acted on appropriately, and the remaining data, for example voice data, is processed for use or further transmission. Since delay-critical data is transferred within a frame and within data packets containing other, non-critical data it is necessary for an entire frame to be received before the receiving equipment can respond to the delay-critical data. Due to interspersion of data packets as explained above, there could be a delay before this delay-critical data is available for the receiving equipment to act upon, thus the user could experience a drop in service quality.

It would be desirable to provide a way of reducing the delay for transfer and decoding of delay-critical data between network components.

According to one aspect of the present invention there is provided data transmission apparatus for transmitting the data of a data frame as a plurality of packets, comprising: segmentation apparatus capable of identifying delay-critical data within the data frame, and forming a plurality of packets comprising data of the data fine, wherein the identified data is formed in to one or more packets capable of being decoded independently of the other packets; and a transmitter for transmitting the packets. Thus, the receiver can decode the identified data as soon as the data packets including the identified data are received.

According to a second aspect of the present invention there provided a method of transmitting the data of a data frame as a plurality of packets, comprising the steps of: identifying delay-critical data within the data frame; forming a plurality of packets comprising data of the data frame, such that the identified data is formed in to one or more packets capable of being decoded independently of the other packets; and transmitting the packets. This enables the receiver to decode the identified data as soon as the data packets including the identified data are received.

The transmitter is suitably confirmed to transmit the one or more packets capable of being decoded independently of the other packets before transmitting the other packets. Suitably the other packets do not comprise identified data

Preferably the one or more packets capable of being decoded independently of the other packets are transmitted directly to the receiver in immediate succession. The other packets may be transmitted such that they may be interspersed with other data.

The delay-critical data may be signal quality information. The delay-critical data may be data usable for and/or intended for use in control of the system, for example in power control of transmissions in the em Those transmissions may be radio transmissions The delay-critical data may be error information. The delay-critical data may be power control information.

The data frame may be is being transmitted over a telecommunications network interface. Suitably the data frame is transmitted from a base station. Suitably the data Same is transmitted to a radio network controller. Suitably the data frame is transmitted from a mobile telephone, Suitably the data frame is transmitted to a base station. Suitably the data frame is transmitted from a radio network controller, Suitably the data frame comprises voice information.

The said one or more packets capable of being decoded independently of the other packets are suitably transmitted before the other packets. Suitably the other packets do not comprise identified data. Suitably the one or more packets capable of being decoded independently of the other packets are transmitted directly to the receiver in immediate succession. Suitably the other packets are transmitted interspersed with other data

A preferred embodiment of the present invention will now be described by way of example, with reference to the accompanying drawings, in which:

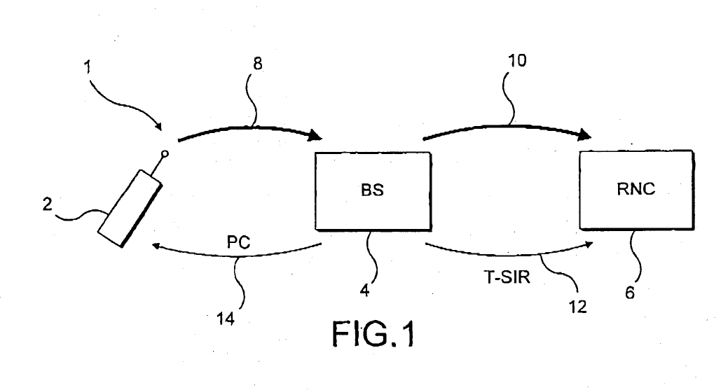

FIG. 1 is a schematic representation of outer loop power control on the uplink side.

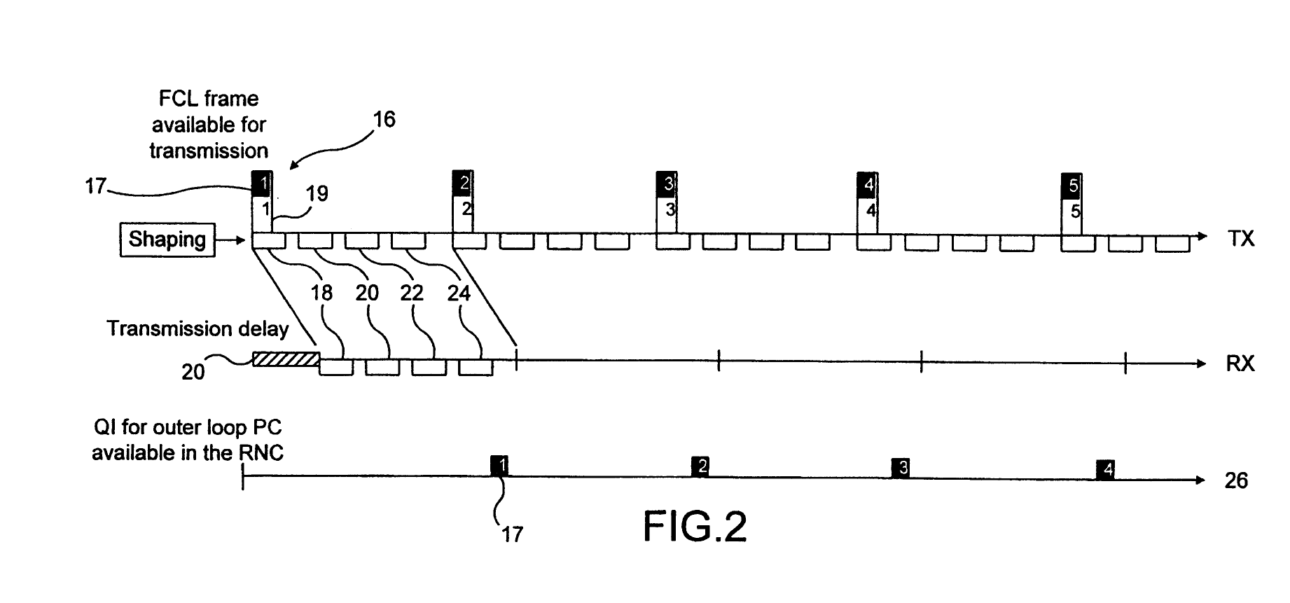

FIG. 2 is a graphical representation of outer loop power control delay according to the prior art.

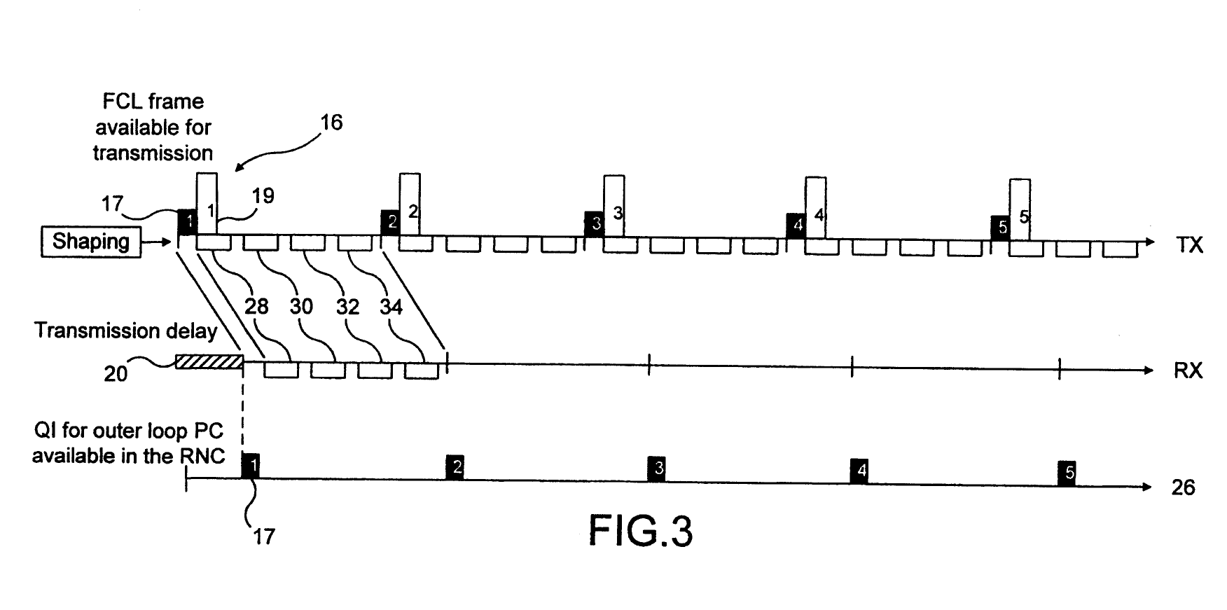

FIG. 3 is a graphical representation of the method of-.minimuising outer loop power control delay according to the present invention.

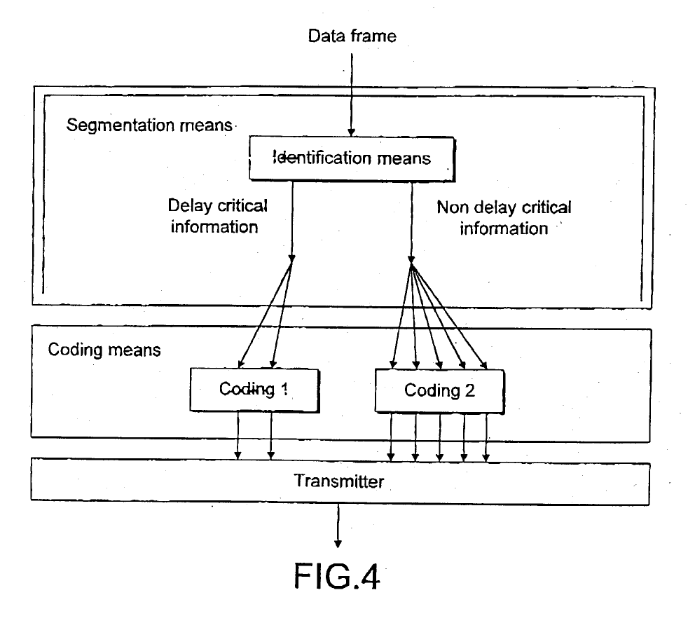

FIG. 4 is a schematic presentation of a transmitter according to the invention.

In the figures, like reference numerals indicate like parts.

The present invention will be described with specific reference to the terminology appropriate to the proposed UMTS System, but it will be understood that the invention may as well be applied in other systems.

FIG. 1 shows components forming part of a proposed wideband code division multiple access (WCDMA) mobile telecommunications network which are involved in outer loop power control on the uplink side, indicated generally as 1. A mobile phone is shown as 2, a base station (BS) is shown as 4 and a radio network controller (RNC) is shown as 6.

FIG. 1 also shows the signals for outer loop power control. There is a first traffic signal, indicated as 8 which is sent from the mobile phone 2 to the RNC and a second signal quality information signal in the form of a bit error rate (BER), indicated as 10, which is sent from the BS to the RNC 6. There is also a target signal-to-interference ratio (T SIR) information signal 12 which is sent from the RNC 6 to the BS and a power control (PC) signal 14 which is sent from the BS to the mobile phone 2. Alternatively, the RNC may calculate a frame error ratio for the received CDMA frames, which may be transmitted to the BS, and the BS may then control the mobile station so as to maintain that ratio.

The components and signals represented in FIG. 1 are considered to be “the uplink side” because they are used to control the power with which the mobile phone 2 transmits to the RNC. For completeness, “downlink power control” refers to control of the power with which the RNC transmits signals to a mobile phone.

In a mobile telecommunications network, a part of which is shown in FIG. 1, there are a large number of base stations with which mobile phones communicate as appropriate depending on their location and other factors. Each RNC controls a group of base stations and one of its responsibilities is to maintain signal quality across all these base stations and all the mobile phones in the area of these base stations For this reason, the power control of a mobile phone is a two-stage process involving an inner loop of signals between the mobile phone and the BS (signals 8 and 14) and an outer loop of signals between the BS and the RNC (signals 10 and 12). The outer loop control signals are carried over an I_{UB} interface and the RNC is the serving radio network controller (SRNC) for its area. Such power control is of particular importance in a WCDMA network since a theoretically unlimited number of mobile phones can connect to any one base station. The power control process will now be described in greater detail with reference to FIG. 1.

The transmission of signals is a continuous process, but arbitrarily considering the start of the process to be at the mobile phone 2, the first signal to be sent is signal 8, which in this embodiment is voice traffic. It could alternatively be data, multimedia or messaging traffic, for example. This voice traffic is sent from mobile phone 2 to the BS, so that the BS can transmit voice data to the phone of the person with whom the user of mobile phone 2 is speaking. The RNC measures and stores the signal-to-interference ratio (SIR) of the signal 8 and measures and passes onto the RNC the bit error rate (BER) of signal 8 (indicated by 10). Both the SIR and the BER are an indication of the quality of signal received by the RNC from mobile phone 2. An alternative would be to use a frame error rate signal. The RNC uses this BER information, equivalent information regarding other mobile phones from the RNC, equivalent information from other base stations and other factors such as the number of mobile phones attached to each base station, to produce a target SIR (T SIR) signal 12. It might also carry out other network control functions such as forcing mobile phones to handover should too many be attached to one base station.

When the BS receives the T SIR signal 12, it compares it to the SIR value of the traffic signal 8 received from the MS 2. On this basis, it sends a power control (PC) signal 14 to the mobile phone 2 which takes one of two forms. Either it is a 1 signal instructing the mobile phone 2 to increase its power by 1 dB or it is a 0 signal instructing the mobile phone 2 to decrease its power by 1 dB. The mobile phone uses this instruction to send its next voice traffic signal at 1 dB above or below the previous signal (8) which it sent. The purpose of a power control regime like this is to ensure that all mobile phone users within the area covered by the BS have an acceptable level of service. For example, if too many mobile phones were operating at too high a power, the level of interference would become unacceptable for a large number of users. It follows that in order for the power control process to work well, delays in the receiving and processing of the four signals indicated in FIG. 1 need to be avoided, otherwise the level of service could be disrupted for an unacceptable length of time.

In this embodiment the transmission of certain data is delay-critical since delays in the receipt of that data is likely to result in a drop in service quality. For example, the power control data such as the SIR and BER contained in signal 8, the BER signal 10, the TSIR signal 12 and the PC signal 14 are delay-critical signals. In this and other systems other information may be delay-critical.

The four signals 8, 10, 12, 14 discussed above are carried in data frames, known as frame control layer (FCL) or user plane protocol frames and are transmitted over an interface, which in the case of outer loop signals is an I_{UB} interface as stated previously. Such interfaces have receiving and transmitting layers for controlling data to and from each component, which in this embodiment are AAL2 transport layers. If an FCL frame is larger than 45 octets, the transmitting AAL2 transport layer segments the FCL frame into data packets and transmits these. Upon reception at the receiving component, the receiving AAL2 transport layer reassembles the frame and then passes it onto the receiving component. It is not possible for the AAL2 transport layer to pass any part of an FCL frame to a component until the entire frame has been reassembled.

In a WCDMA system, one possible source of delay is shaping, which is the interspersion of data packets forming part of different data frames. Shaping is advantageous because it reduces jitter as any one user occupies the available bandwidth only for short durations. Thus, it is quite possible, for example, that the RNC will experience some delay before receiving an entire data fame of the voice traffic signal 8. An alterative to shaping is burst transmission, in which all the data packets of a frame are transmitted in immediate succession.

Returning now to FIG. 1, all four signals 8, 10, 12, 14 include data frames which need to be segmented into packets and the components 2, 4, 6 are connected by AAL2 transport layers which shape the signals. Furthermore, the uplink power control information which these frames include is delay-critical for the reasons discussed above. Taking the voice traffic signal 8 transmitted from the mobile phone 2 to the RNC as an example, SIR information is contained within each data frame of this signal In prior art systems, the data frames are segmented in the normal way, resulting in the delay-critical SIR information being in one or more data packets, which packets are then shaped with other packets. It is therefore necessary for all the data packets of a data frame to be received and reassembled before the frame, and therefore the SIR information, can be passed onto the RNC. Due to the shaping, this is likely to result in an unacceptable delay before the SIR information is available to the RNC, which puts a delay on the entire power control loop.

This situation is depicted in FIG. 2, in which the transmission of data packets from the base station is labelled as time line TX and the receiving of data packets by the RNC is labelled as time line RX. The FCL frames are numbered 1, 2, 3 etc. and the first frame is indicated by reference numeral 16. Frame 16 contains delay-critical data 17 and non-delay-critical data 19. The whole of data frame 16 is segmented into four data packets, labelled as reference numerals 18, 20, 22, 24. Subsequent data frames are similarly segmented. There is also shown a third time line 26 which shows when The delay-critical data is received by the RNC. Delay-critical data 17 is labelled at the point in time at which it is received.

Data packets 18, 20, 22, 24 are shaped such that they are transmitted interspersed with data packets from other data frames (not shown). It can be seen that there is a transmission delay indicated as block 20. This means that from the beginning of the segmentation process to the instant when the RNC receives the first packet 18, there is a delay of length in time indicated by block 20. The subsequent three packets 20, 22, 24 are transmitted at time intervals after packet 18, as indicated on time line TX, and are also subject to delays, hence they arrive at the SAC at intervals after the arrival of packet 18, as indicated on time line RX. Thus there is a total delay for the entire packet to arrive at the RNC. Since the AAL2 transport layer needs to have received all four packets of frame 16 in order to decode and reassemble the frame, this total delay is also the delay before which the delay-critical SIR information is received by the RNC, as indicated by the position of the delay-critical data 17 on time line 26. A similar delay occurs in transmission of the subsequent data frames 2,3 etc. There are also similar delays in transmission of the other signals 10, 12 and 14, hence the total power control loop delay is significant. It should be noted that FIG. 2 is only a diagrammatic indication of the delays to indicate the principle of the problem and that in practice they would not all be of equal duration, and furthermore, the problem exists for different sized data frames which are segmented into different numbers of data packets.

In an embodiment of the present invention, when the AAL2 transport layer is required to transmit a data frame, it first of all identifies the delay-critical BER information (and any other delay-critical information) within the frame, and forms it into a single data packet. The remaining data from the frame is formed into four other packets. The single data packet is then transmitted directly over the interface to the receiving AAL2 transport layer, without shaping. This receiving AAL2 transport layer is capable of decoding this packet independently, that is without having to wait for the remaining packets of the data fame to arrive. Having decoded the packet it passes it onto the RNC. This means that the delay for the RNC to receive the SIR and BER information is greatly reduced. This in turn means that the RNC can transmit the SIR information to the BS 4 before it has received the entire frame. This results in the T SER (signal 12) and the PC signal 14 being generated and transmitted earlier, which means the instructions for power variation are received much sooner by the mobile phone 2 and hence it can alter its power quickly, thus maintaining service levels for the user. If the signals 10, 12 and 14 are also transmitted by a similar method, the reduction in delay for the entire power control loop would be very significant.

The remaining four packets are transmitted after the first packet with shaping. They are therefore subject to the normal delays which are acceptable for voice traffic data.

This preferred embodiment is depicted in FIG. 3, in which frame 16 is shown after the delay-critical data 17 has been identified and separated into a single packets leaving the remaining non-delay-critical data 19 to be segmented into four further packets, labelled as 28, 30, 32, 34. Delay-critical data 17 is sent directly to the receiving AAL2 transport layer without shaping, therefore it is only subjected to delay 34 which is the result of segmentation and decoding, and is received at the RNC after this delay 34 as shown on time line 26. It is decoded immediately. The remaining packets 28, 30, 32, 34 are transmitted with shaping, and are therefore each subject to delays. Therefore there is a total delay for the entire packet to be received, but this is an acceptable delay since the SIR and BER information has already been decoded. It should be noted that FIG. 3 is only a diagrammatic indication of the delays to indicate the principle of the problem and that in practice they would not all be of equal duration, and furthermore, a similar embodiment would work for different sized data names which are segmented into different numbers of non-delay-critical data packets.

It would be possible for the first packet to contain non-delay-critical data as well as delay-critical data, in which case, the AAL2 transport layer could either be set up to decode the entire packet for passing on to the RNC or to decode just the delay-critical data for passing on to the RNC and store the remaining data until the rest of the frame is received.

It would also be possible for a packet of delay-critical data to be formed, either with or without additional non-delay-critical data, and for it to be transmitted with shaping as normal. This would still provide an advantage because that packet would be decoded as soon as it arrived, even if not all of the other packets had arrived.

If the amount of delay-critical data were too great to form only one packet, it could be formed into more than one packet, either with our without additional non-delay-critical data, and all these packets could be transmitted directly, without shaping, in immediate succession, to the RNC. Alternatively, they could be transmitted with shaping, but would each be capable of being decoded independently such that the RNC could act on the delay-critical information. A further possibility is that it would be necessary for all packets containing delay-critical data to be received before any of them could be decoded. Any of these methods would provide an advantage over the prior art.

The sane principle could be applied to power control of the downlink side, so that the power control information required for signals being transmitted from the RNC to the mobile 2 could be updated quickly.

FIG. 4 shows a schematic presentation of a transmission apparatus according to the invention. The apparatus comprises:

segmentation apparatus having an identification means capable of identifying delay-critical data within the data frame, and forming a plurality of packets comprising data of the data frame, wherein the identified data is formed in to one or more packets capable of being decoded independently of the other packets; and

a transmitter for transmitting the packets.

Preferably, the apparatus also comprises coding means which is adapted to encode the identified delay-critical data with coding 1 independently of the other data of the data frame, and to encode The other data of the data frame using a second coding 2. Coding 1 and coding 2 can be the same coding method, or they may be different coding methods.

The invention would also work for other types of delay-critical data such as error information, which in this system is a CRC checksum, timing advance requests and CODEX video quality algorithm data. According to some embodiments of the invention, the delay critical data can as well be user data such as voice data The invention could also be applied to other types of network such as GSM mobile telecommunications networks and data networks.

1. Data transmission apparatus for transmitting the data of a data frame as a plurality of packets, comprising:
segmentation apparatus capable of identifying delay-critical data within the data frame, and forming a plurality of packets comprising data of the data frame, wherein the identified data is formed in to one or more packets capable of being decoded independently of the other packets; and
a transmitter for transmitting the packets.

2. Data transmission apparatus according to claim 1, wherein the transmitter is configured to transmit the one or more packets capable of being decoded independently of the other packets before transmitting the other packets.

3. Data transmission apparatus according to claim 1 or claim 2, wherein the other packets do not comprise identified data.

4. Data transmission apparatus according to any preceding claim, wherein the one or more packets capable of being decoded independently of the other packets are transmitted directly to the receiver in immediate succession.

5. Data transmission apparatus according to any preceding claim, wherein the other packets are transmitted such that they may be interspersed with other data.

6. Data transmission apparatus according to any preceding claim, wherein the delay-critical data is signal quality information.

7. Data transmission apparatus according to any preceding claim, wherein the delay-critical data is error information.

8. Data transmission apparatus according to any preceding claims wherein the delay-critical data is power control information.

9. Data transmission apparatus according to any preceding claim, wherein the data frame is transmitted over a telecommunications network interface.

10. Data transmission apparatus according to claim 9, wherein the data frame is transmitted from a base station.

11. Data transmission apparatus according to claim 9 or claim 10, wherein the data frame is transmitted to a radio network controller.

12. Data transmission apparatus according to any of claims 9 to 11, wherein the data frame is transmitted from a mobile telephone.

13. Data transmission apparatus according to claim 9, wherein the data frame is transmitted to a base station.

14. Data transmission apparatus according to claim 9 or claim 10, wherein the data frame is transmitted from a radio network controller.

15. Data transmission apparatus according to any preceding claim, wherein the data frame comprises voice information.

16. Data transmission apparatus according to any preceding claim, substantially herein as described with reference to the accompanying drawings.

17. A method of transmitting the data of a data frame as a plurality of packets, comprising the steps of:
identified delay-critical data within the data frame;
forming a plurality of packets comprising data of the data frame, such that the identified data is formed in to one or more packets capable of being decoded independently of the other packets; and
transmitting the packets.

18. A method according to claim 17, wherein the one or more packets capable of being decoded independently of the other packets are transmitted before the other packets.

19. A method according to claim 17 or claim 18, wherein the other packets do not comprise identified data.

20. A method according to any of claims 17 to 19, wherein the one or more packets capable of being decoded independently of the other packets are transmitted directly to the receiver in immediate succession.

21. A method according to any of claims 17 to 20, wherein the other packets are transmitted interspersed with other data.

22. A method substantially herein as described with reference to the accompanying drawings.
